(19) United States
(12) Patent Application Publication
(10) Pub. No.: US 2007/0059490 A1
(43) Pub. Date: Mar. 15, 2007

(54) Protective film

(75) Inventor: Yasuhisa Kaneko, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/520,728

(22) Filed: Sep. 14, 2006

(30) Foreign Application Priority Data
Sep. 15, 2005 (JP) 205-268778

(51) Int. Cl. G11B 5/64

(52) U.S. Cl. 428/141

(57) ABSTRACT

The protective film includes a transparent supporting substrate, and a protective layer that is formed on a surface of the supporting substrate and contains fluorine. The protective layer has an uneven surface structure obtained by periodically and continuously forming recesses and projections and the uneven surface structure satisfies relations of t≦390/nb (nm) and h/t ≦0.4. Herein, t represents a period (nm) of the uneven surface structure, h represents a height (nm) which is a distance between a top of each of the projections and a bottom of each of the recesses, and nb represents a refractive index of the protective layer.

### BACKGROUND OF THE INVENTION

The present invention relates to a protective film having both of antireflection function and anti-smudging function, and more specifically a protective film that is used in liquid crystal display panels or other display devices, protects their display screens against smudges and at a time achieves reduction of light reflected from the display screens.

Nowadays, flat panel displays (FPDs) are mainly employed for the display devices along with the popularization of liquid crystal displays and plasma displays.

Touch panels whose display screens are directly touched with a finger or a pen to perform device operation are increasingly used as in automatic teller machines (ATMs) or Tablet PCs of the pen-based input type.

In order to operate a device, such a touch panel is provided with a detector for detecting the operation that is made on the surface of the display screen. The detector is, for example, a conductive sheet which detects the pressure of a pen or a finger, and a specified operation of the device is executed based on the detection result obtained.

However, the detector provided on the display screen of the display device reduces light output from the display device. Further, the display screen is directly touched with a finger or a pen, so fingerprints, sebum, sweat, cosmetics and the like having adhered to the screen by touching it with a finger deteriorate the visibility. Under the circumstances, it becomes important to take anti-smudging measures and various methods for preventing smudges have been proposed (see, for example, JP 2000-144097 A).

Such display devices are extensively used for example in offices, at home and outdoors. In this case, outside light reflected on a display device is a factor that deteriorates the display quality to make it difficult to discriminate the contents displayed on the display screen, for example. Outside light reflected on the display device also becomes a factor that causes visual fatigue or other health problems. Therefore, an antireflection film covering a wide range of visible light is increasingly required.

In order to meet this requirement, antireflection films having the antireflection function over a wide range of visible light have been conventionally proposed (see, for example, JP 11-64602 A, JP 2004-205990 A and S. J. Wilson and M. C. Hutley, Optica Acta, Vol. 29 (1982) pp. 993-1009). The last-mentioned document is hereinafter referred to as “Non-Patent Document 1”.

JP 2000-144097 A discloses an anti-smudge agent used for forming an anti-smudge layer on the surface of any of various substrates to be treated and requiring anti-smudging properties. The anti-smudge agent in JP 2000-144097 A includes a fluorine-containing organosilicon compound. JP 2000-144097 A also discloses a reflection preventive member having the anti-smudge layer formed on the surface of a transparent substrate on which a reflection preventive film is formed. Coating the surface of the transparent substrate with a fluorine-based thin film having a low surface tension forms this anti-smudge layer.

JP 11-64602 A discloses an antireflection film in which high refractive index layers each having a refractive index of at least 1.80 and low refractive index layers each having a refractive index of not more than 1.70 are alternately formed at least on one side of a film substrate to form an antireflection layer and in which at least one of the low refractive index layers of the antireflection layer is made of an organic resin. The antireflection film in JP 11-64602 A has a water-repellent and anti-smudge layer formed on the antireflection layer in order to further enhance the anti-smudging properties.

The antireflection film in JP 11-64602 A can be bonded to a glass plate to form an optical member. Use of the optical member in a display device enables enhancement of display quality and more definite discrimination of displayed images.

JP 2004-205990 A discloses an antireflection article on which an uneven micropattern generally called “moth-eye” structure is formed.

The uneven micropattern is a very fine pattern in which the relation of P_{MAX}≦λ_{MIN} where P_{MAX} represents the period of microscopic projections at their vertexes and λ_{MIN} represents the minimal wavelength in a vacuum in the visible light wavelength region is established.

In JP 2004-205990 A, the uneven micropattern satisfying the relation of P_{MAX}≦λ_{MIN} is formed on the surface of the antireflection article, whereby abrupt and discontinuous changes in refractive index at the boundary between the article and the exterior (air) can be turned into continuous and gradual changes in refractive index, leading to a decrease in light reflected from the article surface.

In JP 2004-205990 A, the uneven micropattern can be formed with relative ease by carrying out embossing that involves pressing a stamper against a pattern-forming layer.

Non-Patent Document 1 discloses the optical properties of “moth eye” antireflection surfaces and the antireflection effects achieved by the “moth eye” structure.

### SUMMARY OF THE INVENTION

However, the anti-smudge agent used in JP 2000-144097 A has a contact angle of 73° with respect to n-hexadecane whose surface tension is as low as that of oil, in other words, the contact angle is not more than 90°, and the anti-smudge agent is not repellent to n-hexadecane. Therefore, the anti-smudge agent in JP 2000-144097 A is also not repellent to oil that is a principal component of smudges and is low in surface tension like n-hexadecane. The anti-smudge agent in JP 2000-144097 A is thus disadvantageous in that it does not have sufficiently high anti-smudging properties against oil that constitutes the principle component of smudges.

JP 11-64602 A is disadvantageous in that the wavelength range within which reflection can be prevented is narrow and the production process is complicated because the film is of a multilayer structure.

In both of JP 2004-205990 A and Non-Patent Document 1, the “moth-eye” structure is used to prevent reflection but the anti-smudging properties are not taken into consideration. Therefore, when the techniques in these documents are applied to touch panels, there is posed a problem that their visibility is not prevented from being deteriorated by adhesion of fingerprints, sebum, sweat, cosmetics and the like due to touching with a finger.

The reason why repellency with respect to an organic solvent or oil cannot be easily achieved will be further described below in detail.

As shown in FIG. 15, the contact angle θ formed between a surface 150a of a smooth solid 150 and a liquid 152 placed thereon is represented by the following expression 1 showing the relationship among the surface tension Y_{L} of the liquid 152, the surface tension Y_{S} of the solid 150, and the interaction (interfacial tension) Y_{SL} between the solid 150 and the liquid 152.
γ_{S}=γ_{SL}+γ_{L}·cos θ (1)

In addition, the solid-liquid interfacial tension Y_{SL} is represented by the following expression 2.
γ_{SL}=γ_{S}+γ_{L}−2\sqrt{γ_{S}γ_{L}} (2)

The following expression 3 is derived by combining the expressions 1 and 2. The expression 3 means that the contact angle showing repellency is derived from a magnitude relationship between the surface tension γ_{S} of the solid and the surface tension γ_{L} of the liquid.

$$θ = {cos}^{- 1} ( \sqrt{\frac{4 {γ}_{S}}{{γ}_{L}}} - 1 ) \qquad ( 3 )$$

A contact angle of 90° or more is generally defined as exhibiting “repellency”, while a contact angle of less than 90° is generally defined as exhibiting “lyophilic property” (“Kou Hassui Gijutsu no Saishin Doko” (Latest Trends in High Repellency Technique), TORAY RESEARCH CENTER, Inc., p1). A relationship capable of realizing the repellency is represented by the following expression 4.

$${γ}_{S} < \frac{{γ}_{L}}{4} \qquad ( 4 )$$

That is, the surface tension γ_{S} of the solid must be equal to or less than one fourth of the surface tension γ_{L} of the liquid. The surface tension of water is 74 mN/m. The surface tension γ_{S} of the solid must be equal to or less than one fourth of 74 mN/m, that is, equal to or less than 19 mN/m in order that the solid may exhibit repellency with respect to water. Table 1 below shows the surface tension of each substance. Examples of a solid material having a surface tension of 19 mN/m or less include Teflon® and Cytop®, and each of the materials provides a contact angle θ of 90° or more.

TABLE 1

| | Surface |
|---|---|
| | tension |
| Material | (mN/m) |
| Perfluorolauric acid | 6 |
| Fluoroalkylsilane | 10 |
| Teflon ® | 18 |
| Cytop ® | 19 |
| Polytrifluoroethylene | 22 |
| Polyimide | 23 |
| Silicone | 24 |
| (polydimethylsiloxane) | |
| Polyvinylidene fluoride | 25 |
| Polyvinyl fluoride | 28 |
| Polyethylene | 31 |
| Polystyrene | 33 |
| PMMA | 39 |
| Polyvinylidene chloride | 40 |
| Polyethylene | 43 |
| terephthalate | |
| Nylon ® | 46 |
| Cellophane | 80 |

Meanwhile, an organic solvent, oil or the like has a surface tension much lower than that of water. For example, decane has a surface tension of 24 mN/m, so a solid having a surface tension of 6 mN/m or less is needed to exhibit repellency with respect to such liquid. An example of the solid includes perfluorolauric acid. In actuality, however, this solid is not practical because only a monomolecular film of the order of an atomic layer can be formed from the solid and because the solid exhibits no repellency with respect to water.

Introduction of a surface structure has been known as another method of improving repellency. Models for the surface structure are roughly classified into two models. One model is a Wentzel model shown in FIG. 16 in which microscopic irregularities 156 are formed on the surface of a solid 154 to increase the surface area to thereby increase the contact angle.

In FIG. 16, θ represents the true contact angle (contact angle θ when the surface is smooth (see FIG. 15)) and θ_{f} represents the apparent contact, angle.

The relationship between the contact angle θ and the apparent contact angle θ_{f} is represented by the following expression 5. In the following expression 5, r represents a surface multiplication factor and is represented by a ratio between the true surface area and the apparent surface area.
cos θ_{f}=r·cos θ (5)

In the Wentzel model, one which is lyophilic becomes more lyophilic, and one which is repellent becomes more repellent.

FIG. 17 is a graph showing the relationship between the contact angle θ and the apparent contact angle θ_{f} in the Wentzel model in which the axis of ordinates indicates cos θ_{f} and the axis of abscissas indicates cos θ.

As shown in FIG. 17, in the Wentzel model, unless a material itself has a contact angle of 90° or more (cos θ<0) with respect to a target liquid, it is difficult to further increase the contact angle.

In addition, in the Wentzel model, a straight line L shown in FIG. 17 is obtained when the surface does not have recesses, projections or other surface structure. The surface multiplication factor r in the straight line L is 1 (r=1). On the other hand, a straight line M shown in FIG. 17 is obtained when the surface has recesses, projections or other surface structure. Introduction of a surface structure to the surface increases the surface area, thereby increasing the surface multiplication factor r in the straight line M to be larger than 1 (r>1).

A Cassie model is another surface structure model. As shown in FIG. 18, in the Cassie model, recesses 160 are formed in a solid 158. The recesses 160 are filled with a substance 159 different from the solid 158. When the surface portion is formed of two materials (the solid 158 and the substance 159) having different surface tensions, the apparent contact angle θ_{f} is determined by the relationship among the two materials (the solid 158 and the substance 159) at a surface 158a, a liquid 162, and true contact angles ↓₁ and θ₂ (not shown). The relationship is represented by the following expression 6. In the following expression 6, A₁ and A₂ each represent a coefficient showing the area ratio of each substance in a composite surface. Those coefficients A₁ and A₂ have the relationship represented by the following expression 7.
cos θ_{f}=A·cos θ₁+A₂·cos θ₂ (6)
A₁+A₂=1 (7)

Suppose that one of the two kinds of materials is air, that is, fine recesses and projections are formed on the surface of one material (the solid 158) in the Cassie model. As shown in FIG. 19A, when the solid 158 itself exhibits repellency with respect to the target liquid 162 (θ₁>90°), the liquid 162 cannot enter the recesses 160, so an air layer is present in the recesses 160.

The contact angle θ₂ with respect to the air is 180°. Therefore, the apparent contact angle Of represented by the expression 6 can be newly represented by the following expression 8.
cos θ_{f}=(1−A₂)cos θ₁−A₂
(θ₁<90°, θ₂=0°) (8)

On the other hand, when the single solid 158 exhibits lyophilic property with respect to the target liquid (θ₁<90°), as shown in FIG. 19B, the liquid 162 enters the recesses 160, so the recesses 160 are filled with the liquid 162. At this time, the contact angle of the recesses 160 with respect to the liquid is 0°. Therefore, the apparent contact angle θ_{f} represented by the expression 6 can be newly represented by the following expression 9.
cos θ_{f}=(1−A₂)cos θ₁+A₂
(θ₁<90°, θ₂=0°) (9)

FIG. 20 is a graph showing the relationship between the contact angle θ₁ and the apparent contact angle θ_{f} in the Cassie model in which the axis of ordinates indicates cos θ_{f} and the axis of abscissas indicates cos θ₁.

In the Cassie model as well, as shown in FIG. 20, one which is lyophilic becomes more lyophilic, and one which is repellent becomes more repellent.

It should be noted that there is a description that the Wentzel model is applicable to a sharp change at a contact angle of around 90° in the Cassie model.

A Wentzel-Cassie integrated model obtained by integrating the Wentzel model and the Cassie model has been proposed. The Wentzel-Cassie integrated model shows the properties of both the Wentzel model and the Cassie model.

As shown in FIG. 21, the relationship between the contact angle θ and the apparent contact angle Of in the Wentzel-Cassie integrated model is represented by a polygonal line K. In the Wentzel-Cassie integrated model, any value of the apparent contact angle Of with respect to the contact angle θ as represented by the polygonal line K falls within a first A quadrant D₁₁ as an upper half of a first quadrant D₁ and a third A quadrant D₃₁ of a third quadrant D₃ with the line of cos θ_{f}=cos θ as a boundary. The first A quadrant D₁₁ is a region in which lyophilic property increases and the contact angle reduces. The third A quadrant D₃₁ is a region in which repellency increases and the contact angle increases. In the Wentzel-Cassie integrated model, as shown in FIG. 21, any value of the apparent contact angle θ_{f} with respect to the contact angle θ remains within the first A quadrant D₁₁ and the third A quadrant D₃₁.

Thus, as shown in FIGS. 17, 20, and 21, in each of the Wentzel model, the Cassie model, and the Wentzel-Cassie integrated model, introduction of a surface structure to a solid does not lead to increase in repellency unless the solid itself exhibits repellency with respect to a target liquid, that is, unless the contact angle is more than 90°. Therefore, there is no repellent material capable of forming a contact angle of 90° or more with respect to a liquid having a low surface tension such as an organic solvent or oil. As a result, repellency with respect to an organic solvent or oil cannot be achieved.

An object of the present invention is to solve the above-mentioned conventional problems, and to provide a protective film having both of the antireflection function and anti-smudging function.

In order to achieve the above object, a first aspect of the present invention provides a protective film comprising: a transparent supporting substrate; and a protective layer which is formed on a surface of the supporting substrate and contains fluorine, wherein the protective layer has an uneven surface structure obtained by periodically and continuously forming recesses and projections and the uneven surface structure satisfies relations of t≦390/nb (nm) and h/t≦0.4 where t represents a period (nm) of the uneven surface structure, h represents a height (nm) which is a distance between a top of each of the projections and a bottom of each of the recesses, and nb represents a refractive index of the protective layer.

In the first aspect of the present invention, preferably, each of the projections has a tip whose radius of curvature is less than smaller one of a width and a depth of each of the recesses.

Moreover, in the first aspect of the present invention, preferably, each of the projections has a tip whose radius of curvature is equal to or less than half of smaller one of a width and a depth of each of the recesses.

Furthermore, in the first aspect of the present invention, preferably, an area ratio of the projections to the protective layer is not more than 60%.

Further, in the first aspect of the present invention, preferably, an area ratio of the projections to the protective layer is not more than 40%.

Moreover, in the first aspect of the present invention, preferably, an area ratio of the recesses to the protective layer is at least 20%.

Further, in the first aspect of the present invention, preferably, an area ratio of the recesses to the protective layer is at least 40%.

Moreover, a second aspect of the present invention provides a protective film comprising: a transparent supporting substrate which has an uneven surface structure obtained by periodically and continuously forming recesses and projections on its surface, the uneven surface structure satisfying relations of t≦39/nb (nm) and h/t≦0.4 where t represents a period (nm) of the uneven surface structure, h represents a height (nm) which is a distance between a top of each of the projections and a bottom of each of the recesses, and nb represents a refractive index; and an anti-smudging layer which is formed on the surface of the supporting substrate while the uneven surface structure is maintained and which is made of a fluorine-containing material.

In the second aspect of the present invention, preferably, each of the projections has a tip whose radius of curvature is less than smaller one of a width and a depth of each of the recesses.

Moreover, the second aspect of the present invention, preferably, each of the projections has a tip whose radius of curvature is equal to or less than half of smaller one of a width and a depth of each of the recesses.

Further, the second aspect of the present invention, preferably, an area ratio of the projections to the supporting substrate is not more than 60%.

Furthermore, the second aspect of the present invention, preferably, an area ratio of the projections to the supporting substrate is not more than 40%.

Moreover, the second aspect of the present invention, preferably, an area ratio of the recesses to the supporting substrate is at least 20%.

Further, the second aspect of the present invention, preferably, an area ratio of the recesses to the supporting substrate is at least 40%.

Furthermore, the second aspect of the present invention, preferably, a bottom substrate is provided on a back side of the supporting substrate.

The protective film according to the first aspect of the invention has an uneven surface structure obtained by periodically and continuously forming recesses and projections on a fluorine-containing protective layer. The uneven surface structure satisfies the conditions of t≦390/nb (nm) and h/t≧0.4 where t represents the period (nm), h represents the height (nm) and nb represents the refractive index of the protective layer. In this way, fluorine in the protective layer contributes to the liquid-repellent effect, whereas the uneven surface structure satisfying the above conditions has the antireflection effect. The protective film having both of the anti-smudging performance and the antireflection performance can be thus obtained.

The protective film according to the second aspect of the present invention has an uneven surface structure obtained by periodically and continuously forming recesses and projections on a supporting substrate. The uneven surface structure satisfies the conditions of t≦390/nb (nm) and h/t≧0.4 where t represents the period (nm), h represents the height (nm) and nb represents the refractive index of the supporting substrate. Then, an anti-smudging layer made of a fluorine-containing material is formed on the supporting substrate while the uneven surface structure is maintained. In this way, the uneven surface structure satisfying the above conditions has the antireflection effects, whereas fluorine in the anti-smudging layer contributes to the liquid-repellent effect. The protective film having both of the anti-smudging performance and the antireflection performance can be thus obtained.

The protective films according to the first and second aspects of the present invention have both of the anti-smudging performance and antireflection performance, so outside light or fluorescent light of a fluorescent lamp reflected on the display surface is reduced. Therefore, the visibility of displayed images is enhanced while the burden on the eyes of an operator can be reduced. In addition, fingerprints, sebum, sweat, cosmetics and the like are not readily adhered to the protective film and even if fingerprints, sebum, sweat, cosmetics and the like are adhered, they are readily removed. Accordingly, in the case where a display screen of any of various monitors or a touch panel display screen is provided with the protective film, excellent visibility, high resistance to smudging and easy removal of smudges are achieved to prevent the visibility from being reduced by smudges while the operation for smudge removal can be simplified owing to the high resistance to smudging. The protective film can be thus appropriately attached to the display screen of any of various unmanned monitors or the touch panel display screen.

### BRIEF DESCRIPTION OF THE DRAWINGS

In the accompanying drawings:

FIG. 1 is a graph showing a repellency increasing region and a lyophilic property increasing region in which the axis of ordinates indicates cos θ_{f} and the axis of abscissas indicates cos θ;

FIG. 2 is a graph showing a further detailed relationship between the contact angle θ₁ and the apparent contact angle θ_{f} in a surface structure model of the present invention in which the axis of ordinates indicates cos θ_{f} and the axis of abscissas indicates cos θ₁;

FIG. 3A and 3B are schematic sectional views each showing the shape of a recess in the surface structure model of the present invention;

FIGS. 4A and 4B are schematic sectional views each showing the shape of a projection in the surface structure model of the present invention;

FIG. 5A is a schematic view showing a model for calculating the area ratio of a recess having a circular opening in the surface structure model of the present invention;

FIG. 5B is a schematic view showing a model for calculating the area ratio of a columnar projection in the surface structure model of the present invention;

FIG. 6 is a schematic perspective view showing a projection pattern structure including projections;

FIG. 7A is a view for illustrating reflection from a medium having a constant refractive index;

FIG. 7B is a view showing the refractive index profile in FIG. 7A;

FIG. 8A is a view illustrating reflection from a medium having a continuous refractive index profile;

FIG. 8B is a view showing the refractive index profile in FIG. 8A;

FIG. 9A is a view showing an uneven surface structure which reduces light reflection;

FIG. 9B is a view showing the refractive index profile in the uneven surface structure shown in FIG. 9A;

FIG. 10A is a schematic sectional view showing a protective film according to a first embodiment of the present invention;

Fig. 10B is a schematic plan view of the protective film shown in FIG. 10A;

FIG. 11 is a sectional view taken along the line I-I in Fig. 10B;

FIG. 12A is a schematic sectional view showing the protective film according to a second embodiment of the present invention;

FIG. 12B is a schematic plan view of the protective film shown in FIG. 12A;

FIG. 13 is a sectional view taken along the line II-II in FIG. 12B;

FIG. 14 is a schematic sectional view showing the protective film according to a third embodiment of the present invention;

FIG. 15 is a schematic view showing a relationship among the surface tension of a liquid droplet dropped on a flat surface, the surface tension of a solid, the interfacial tension between the solid and the liquid droplet, and the contact angle;

FIG. 16 is a schematic view showing a Wentzel model;

FIG. 17 is a graph showing a relationship between the contact angle θ and the apparent contact angle θ_{f} in the Wentzel model in which the axis of ordinates indicates cos θ_{f} and the axis of abscissas indicates cos θ;

FIG. 18 is a schematic view showing a Cassie model;

FIG. 19A is a schematic sectional view showing a state where a solid has repellency in the Cassie model;

FIG. 19B is a schematic sectional view showing a state where the solid has lyophilic property in the Cassie model;

FIG. 20 is a graph showing a relationship between the contact angle θ₁ and the apparent contact angle θ_{f} in the Cassie model in which the axis of ordinates indicates cos θ_{f} and the axis of abscissas indicates cos θ₁; and

FIG. 21 is a graph showing a relationship between the contact angle θ and the apparent contact angle Of in a Wentzel-Cassie integrated model in which the axis of ordinates indicates cos θ_{f} and the axis of abscissas indicates cos θ₁.

### DETAILED DESCRIPTION OF THE PREFERRED EMBODIMENTS

The protective film of the present invention will be described below in detail with reference to preferred embodiments shown in the accompanying drawings.

The inventor of the present invention has made extensive studies about a surface structure and a repellent material. As a result, he has found that repellency is increased by the effect based on the modification of the Wentzel and Cassie models owing to optimization of surface structure and optimization of repellent material, whereby improvement from lyophilic property to repellency is possible. That is, he has found that even in a solid having a contact angle of 90° or less (a lyophilic material), the contact angle is increased to 90° or more, or increased to some extent although the contact angle is not more than 90° depending on the surface structure. Thus, he has found means for achieving high repellency by increasing the contact angle with respect to a liquid having a low surface tension such as oil that is a principle component of smudges, whereby the present invention has been achieved.

The inventor of the present invention has also found that an uneven surface microstructure (moth-eye structure) can considerably enhance the antireflection function and be more easily formed than conventional antireflection films, and is similar to an uneven surface microstructure that exhibits the anti-smudging properties. The inventor has made further extensive studies and as a result found the conditions under which the antireflection function and the anti-smudging function can be both satisfied, and thus achieved the invention of the protective film having both of the anti-smudging function and the non-reflection function (antireflection function).

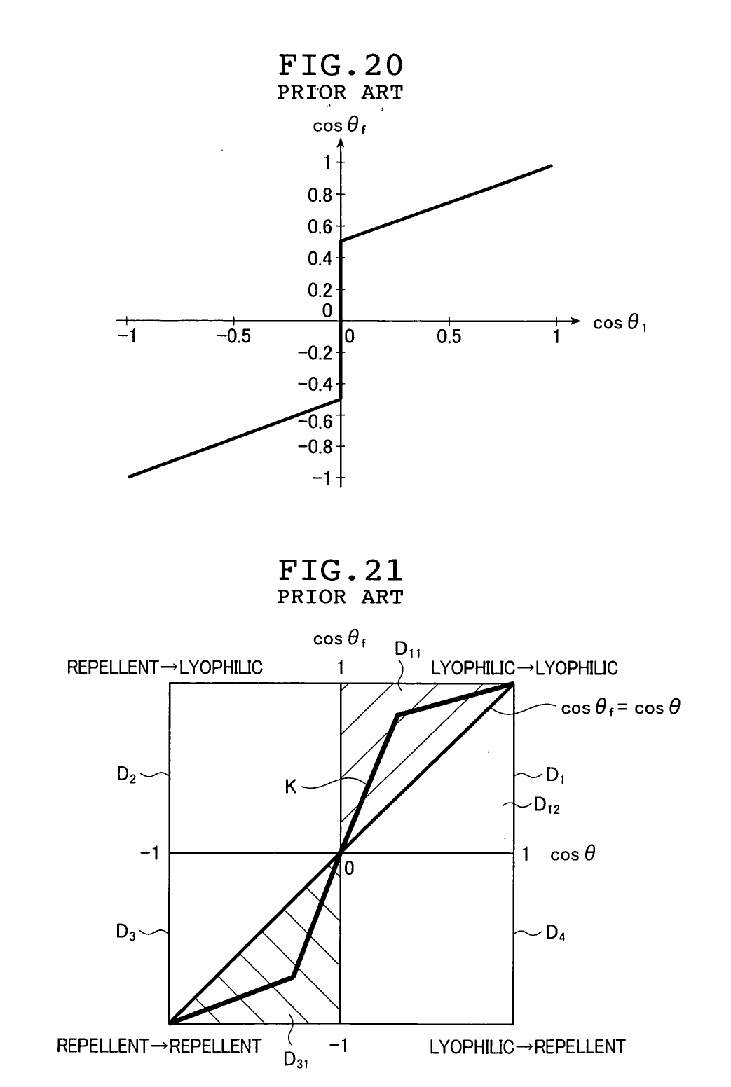

In a generally well known model (such as the Wentzel model or the Cassie model), it is impossible to improve repellency unless a solid material itself has repellency (see FIG. 17, FIG. 20, and FIG. 21). According to such models, it can be easily expected that a large contact angle is obtained with respect to a liquid having a high surface tension such as water, but the solid material has a small contact angle with respect to a liquid having a low surface tension such as an organic solvent or oil and hence has no repellency. In many reports, high repellency has been reported based on the experimental results obtained with water, but no experiment has been conducted using an organic solvent, oil, or the like. In addition, many inventions showed examples (experimental results) on the repellency with respect to water and no additional experiments have been conducted. Furthermore, a description indicating repellency with respect to an organic solvent, oil, or the like can also be found, although lack of repellency can be expected from a conventional model. It cannot be said that those inventions were obtained from correct findings.

As shown in FIG. 21, in the Wentzel-Cassie integrated model, any value of the apparent contact angle θ_{f} with respect to the contact angle θ as represented by the polygonal line K falls within the first A quadrant D₁₁ of the first quadrant D₁ and the third A quadrant D₃₁ of the third quadrant D₃ with the line of cos θ_{f}=cos θ as a boundary, and moves only in the first A quadrant D₁₁ and the third A quadrant D₃₁. The first A quadrant D₁₁ is a region in which lyophilic property increases and the contact angle reduces. The third A quadrant D₃₁ is a region in which repellency increases and the contact angle increases. In the Wentzel-Cassie integrated model, it can also be easily expected that, even when a large contact angle is obtained with respect to a liquid having a high surface tension such as water, the contact angle with respect to a liquid having a low surface tension such as an organic solvent or oil is small and hence no repellency is exhibited.

The other regions of FIG. 21 are seen next. A first B quadrant D₁₂ is a region in which lyophilic property is reduced (that is, repellency is increased) by introducing a surface structure to a solid material having lyophilic property. In the first B quadrant D₁₂, the contact angle is increased by introducing a surface structure; provided, however, that the contact angle is 90° or less.

A fourth quadrant D₄ is a region in which a solid material having lyophilic property is changed to a repellent material by introducing a surface structure to the solid material. This means that the introduction of a surface structure increases the contact angle of a solid material of 90° or less to 90° or more.

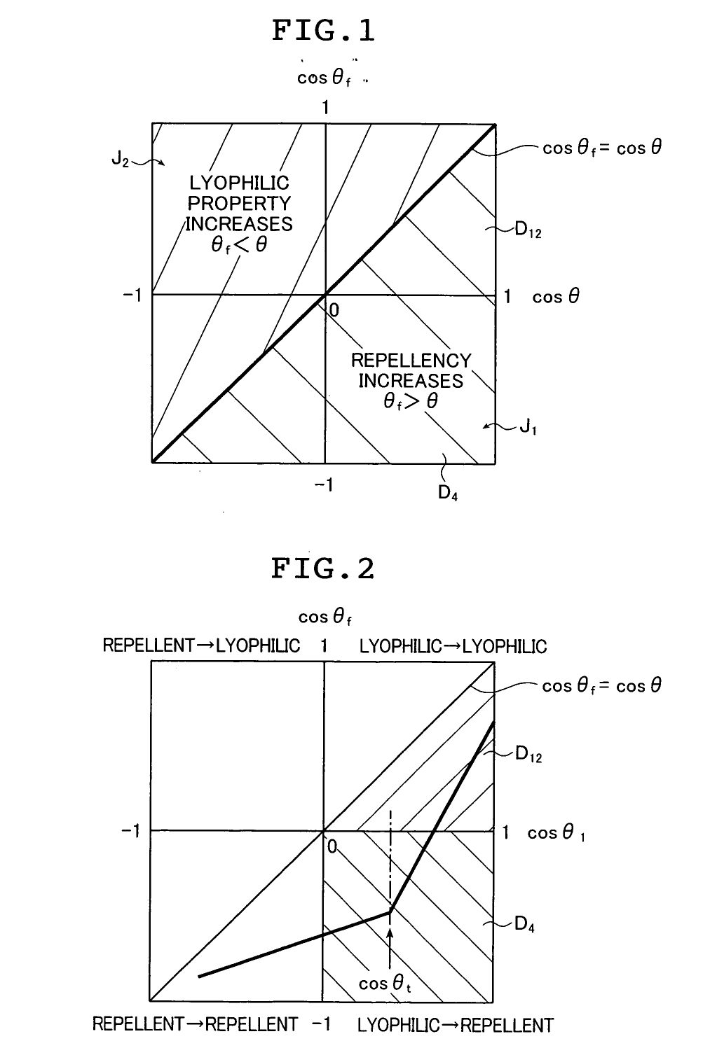

Therefore, each of the third A quadrant D₃₁, the first B quadrant D₁₂, and the fourth quadrant D₄ can be said to be a region in which repellency increases. As shown in FIG. 1, a region J₁ in a lower half and a region J₂ in an upper half with respect to the line of cos θ_{f}=cos θ as a boundary can be defined as a repellency increasing region and a lyophilic property increasing region, respectively.

In view of the foregoing; the inventor of the present invention has made detailed studies about the profile of the uneven surface structure. As a result, he has found that a conventional Wentzel-Cassie integrated model may be modified. That is, even when the contact angle is 90° or less due to the nature of a material, the contact angle can be increased by introducing a surface structure. This means that, depending on the surface structure used, the apparent contact angle θ_{f} may have a value with respect to the contact angle θ that falls within the first B quadrant D₁₂ or the fourth quadrant D₄ of FIG. 1.

FIG. 2 is a graph showing results obtained by making the detailed studies.

Even when the contact angle θ₁ determined by the nature of a material is 90° or less (cos θ₁>0), the state where the recesses 160 are filled with air is maintained (see FIG. 19 and the expression 8), and the contact angle θ increases.

In this case, the contact angle θ_{f} is represented by the following expressions 10 and 13. The expression 10 holds true even when there is no restriction (θ₁>90°) on the repellency in the Cassie model (the expression 8) and the contact angle θ₁ is 90° or less. The expression 10 holds true when the contact angle 01 is larger than the transition angle θₜ obtained from the expression 11.

$$\begin{matrix}\begin{matrix}cos {θ}_{f} = ( 1 - A ) cos {θ}_{1} - A & ( {θ}_{t} < 90 ° , {θ}_{1} > {θ}_{t} )\end{matrix} & ( 10 ) \\ {θ}_{t} = {cos}^{- 1} ( \frac{b - A}{r + A - 1} ) & ( 11 )\end{matrix}$$

In addition, a modified Wentzel model (the following expression 12) holds true when the contact angle θ₁ is smaller than θt. In the expression 12, an additional factor b is added. The additional factor b is a coefficient that mainly depends on A.

According to the expression 12, any value of the apparent contact angle θ_{f} with respect to the contact angle θ₁ remains within the fourth quadrant D₄ or the first B quadrant D₁₂ as the repellency increasing region even at an angle equal to or larger than the transition angle θₜ. This phenomenon can be observed as if the transition angle at which the transition from a Cassie model to a Wentzel model occurs in a conventional Wentzel-Cassie integrated model shifted toward the right direction (toward cos θ₁=1).
cos θ_{f}=r·cos θ₁−b (θ₁<90°, θ₁<θₜ) (12)

In the present invention, even if a solid is lyophilic with respect to a predetermined liquid, the solid is allowed to be repellent with respect to the predetermined liquid or the contact angle is allowed to increase although the solid remains lyophilic. Such tendency is related to the angle of a recess or projection and the pattern shape.

In general, lyophilic property and repellency are distinguished from each other in relation to the contact angle of 90° but there is no ground thermodynamically. In each of the Wentzel model and the Cassie model, lyophilic property and repellency are separately treated, and the boundary between the two properties is not taken into consideration at all. In the Wentzel model, when the contact angle is 90° in consideration of the nature of the material, the contact angle does not change but remains 90° even through introduction of a surface structure. In the Cassie model, an abrupt change arises at a contact angle of about 90°. In the actual surface, behaviors represented by both the Wentzel model and the Cassie model should be simultaneously present, so detailed examination at a contact angle of about 90° is needed. As a result of the detailed examination made by the inventor of the present invention, it has been found that, in the surface structure according to the Cassie model, the transition angle at which the abrupt change arises differs depending on the structure and that even a lyophilic material can exhibit repellency depending on the surface structure.

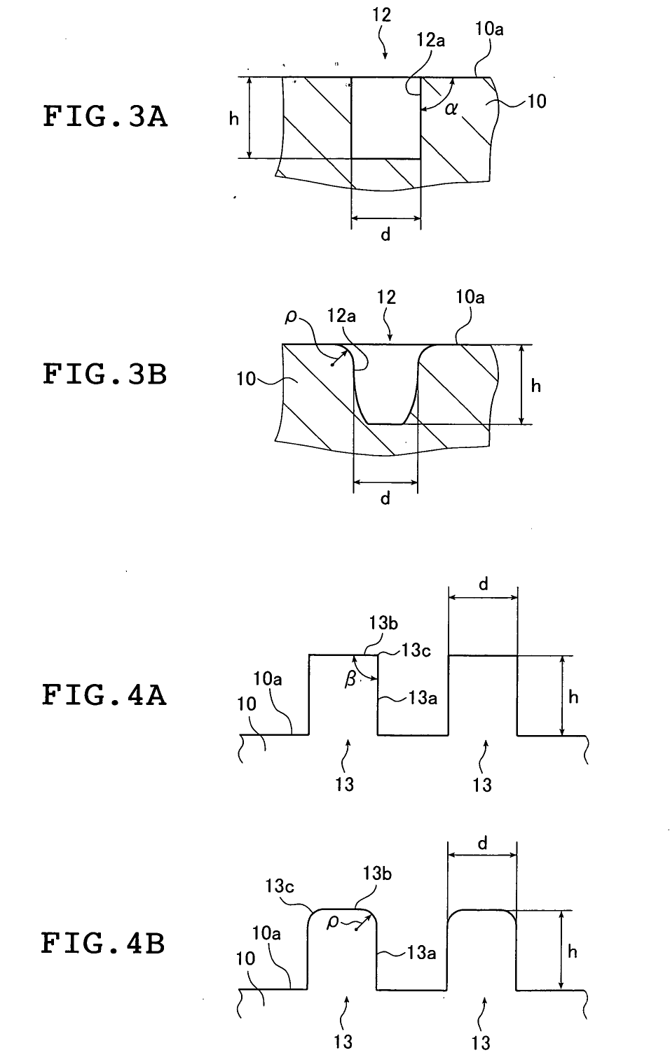

At first, a solid having recesses will be described. In the present invention, as shown in FIG. 3A, a recess 12 whose opening has a circular shape is formed in a solid 10. The recess 12 has a side wall (inner wall) 12a formed so as to be substantially parallel to the thickness direction of the solid 10.

When the boundary between the side wall (inner wall) 12a of the recess 12 and a surface 10a of the solid 10 discontinuously changes, a droplet hardly enters the recess 12. The reason for this is as follows: In order that the droplet may enter the recess 12, air inside the recess 12 must be expelled and exchanged for the droplet. The same holds true for the case where the solid 10 has lyophilic property with respect to the droplet. The transition angle is determined by the ease with which air is exchanged for the droplet. The ease with which air is exchanged for the droplet varies depending on the angle α formed between the side wall 12a in the recess 12 and the surface 10a of the solid 10.

In addition, as shown in FIG. 3B, even when the boundary between the side wall 12a in the recess 12 and the surface 10a of the solid 10 continuously changes, the ease with which air is exchanged for the droplet increases. The radius of curvature at the boundary between the side wall 12a and the surface 10a of the solid 10 is denoted by ρ. The ease with which air is exchanged for the droplet increases depending on the relationship between the radius of curvature ρ, the diameter d of the recess 12, and the depth h of the recess 12, and hence the transition angle θₜ becomes 90° or more. To reduce the transition angle θₜ, the radius of curvature ρ should be less than the smaller one of the diameter d of the recess 12 and the depth h of the recess 12, or desirably equal to or less than half of the smaller one of the diameter d of the recess 12 and the depth h of the recess 12. The depth h is desirably 1 μm or more, and more desirably 2 μm or more.

The diameter d of each recess 12 need only be negligibly small as compared to a droplet, and is desirably 50 μm or less, more desirably 10 μm or less, and still more desirably 5 μm or less.

Next, a solid having projections will be described. In the present invention, as shown in FIG. 4A, two cylindrical projections 13 are independently formed on a solid 10. Each of the projections 13 has an outer wall 13a formed so as to be substantially parallel to the thickness direction of the solid 10.

When the boundary between the outer wall 13a and an upper surface 13b of each projection 13 discontinuously changes, a droplet hardly enters a gap between the projections 13. The reason for this is as follows: In order that the droplet may enter the gap between the projections 13, air inside the gap between the projections 13 must be expelled and exchanged for the droplet. The same holds true for the case where the solid 10 has lyophilic property with respect to the droplet. The transition angle is determined by the ease with which air is exchanged for the droplet. The ease with which air is exchanged for the droplet varies depending on the angle β formed between the outer wall 13a in the projection 13 and the upper surface 13b of the projection 13 (hereinafter also referred to as the angle β of a corner 13c).

In addition, as shown in FIG. 4B, even when the boundary between the outer wall 13a and upper surface 13b of the projection 13 continuously changes, the ease with which air is exchanged for the droplet increases. The radius of curvature at the boundary between the outer wall 13a and upper surface 13b of the projection 13 (the corner 13c) is denoted by ρ. The ease with which air is exchanged for the droplet increases depending on the relationship between the radius of curvature ρ, the diameter d of the projection 13, and the height h of the projection 13, and hence the transition angle θₜ becomes 90° or more. To reduce the transition angle θₜ, the radius of curvature ρ should be less than the smaller one of the diameter d of the projection 13 and the height h of the projection 13, or desirably equal to or less than half of the smaller one of the diameter d of the projection 13 and the height h of the projection 13. The height h of the projection 13 is desirably 1 μm or more, and more desirably 2 μm or more.

The diameter d of each projection 13 need only be negligibly small as compared to a droplet, and is desirably 50 μm or less, more desirably 10 μm or less, and still more desirably 5 μm or less. In the present invention, the height of the projection 13 and the depth of the recess are treated as the same thing, and the same reference numeral is given to the height and the depth.

Conditions under which an uneven surface structure is introduced to a lyophilic solid to increase repellency differ depending on the pattern used for the recesses and projections. In addition, the rate at which the contact angle increases owing to the surface structure varies depending on the area ratio of recesses and the surface tension of the solid itself. At first, a pattern in which recesses 12 each having a circular opening or cylindrical projections 13 are formed on the surface of a solid will be described.

Based on the expressions 1 and 10, the relationship among the apparent contact angle Of, the area ratio A, the surface tension of a liquid, and the surface tension of a solid is represented by the following expression 13. In the following expression 13, the relationship by which the apparent contact angle θ_{f} becomes 90° or more is represented by the following expression 14. Even when the contact angle on a flat surface is 90° or less, the contact angle can be made equal to or more than 90°, or can be increased although the contact angle is equal to or less than 90°, by determining a solid material satisfying the relationship with a target liquid and the area ratio A of recesses.

$$\begin{matrix}{θ}_{f} = {cos}^{- 1} [ ( 1 - A ) ( \sqrt{\frac{4 {γ}_{S}}{{γ}_{L}}} - 1 ) - A ] & ( 13 ) \\ A > 1 - \sqrt{\frac{{γ}_{L}}{4 {γ}_{S}}} & ( 14 )\end{matrix}$$

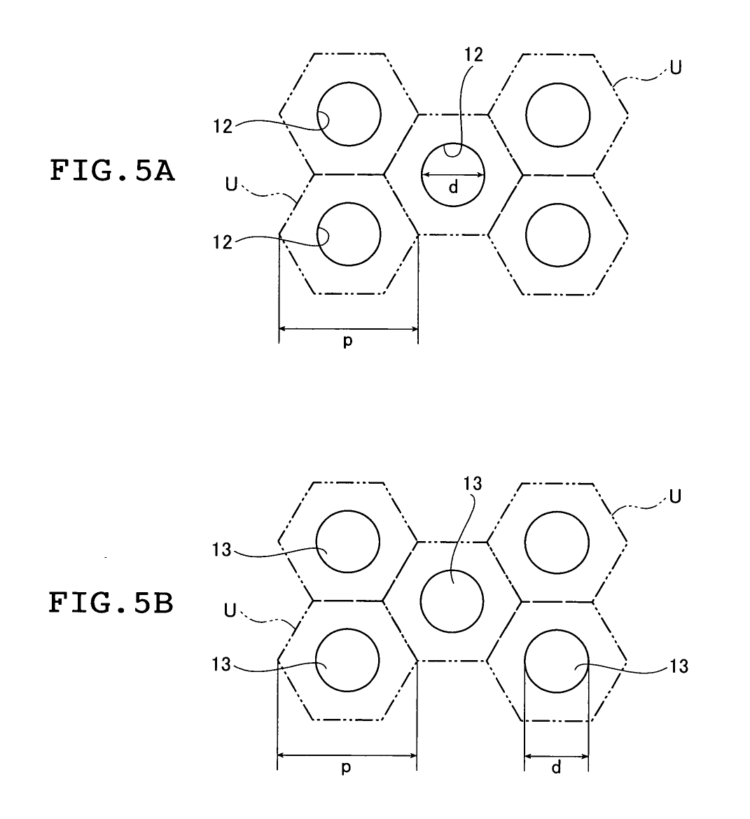

The area ratio A of the recesses 12 in the expressions 13 and 14 is the area ratio of the recesses 12 calculated on the basis of the assumption that the cylindrical recesses 12 having the same size are formed at the centers of virtual hexagons U as shown in FIG. 5A. That is, the area ratio A refers to an area ratio in the case where the recesses 12 are formed in a closest-packed manner. The area ratio A is represented by the following expression 15. In the following expression 15, d represents the diameter of each recess 12 and p represents the size of each hexagon U.

$$A = \frac{2 \sqrt{3} π}{9} {( \frac{d}{p} )}^{2} \qquad ( 15 )$$

The area ratio A of the recesses 12 is preferably 20% or more and more preferably 40% or more. Increase in the area ratio A of the recesses 12 allows the frequency at which liquid contacts air to be increased, thereby increasing the apparent contact angle θ_{f}.

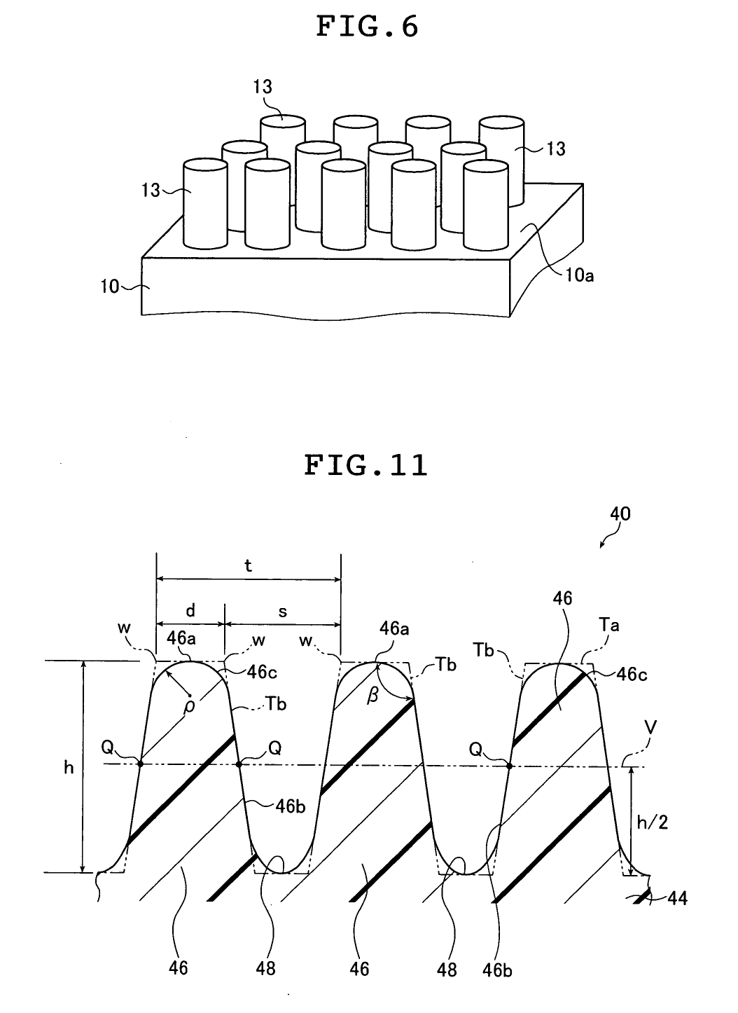

The area ratio A of the projections 13 in a projection pattern including the projections 13 formed on the surface 10a of the solid 10 as shown in FIG. 6 is the area ratio of the projections 13 calculated on the basis of the assumption that the cylindrical projections 13 having the same size are formed at the centers of virtual hexagons U as shown in FIG. 5B. That is, the area ratio A refers to an area ratio in the case where the projections 13 are formed in a closest-packed manner. The area ratio A is represented by the following expression 16. In the following expression 16, d represents the diameter of each projection 13 and p represents the size of each hexagon U.

$$A = 1 - \frac{2 \sqrt{3} π}{9} {( \frac{d}{p} )}^{2} \qquad ( 16 )$$

The area ratio A of the projections 13 to the surface 10a of the solid 10 is preferably 60% or less, and more preferably 40% or less. Decrease in the area ratio A of the projections 13 to the surface 10a of the solid 10 allows the frequency at which liquid contacts air to be increased, thereby increasing the apparent contact angle θ_{f}.

The principle on which the non-reflection function (antireflection function) can be achieved by the uneven surface microstructure will be described below in detail.

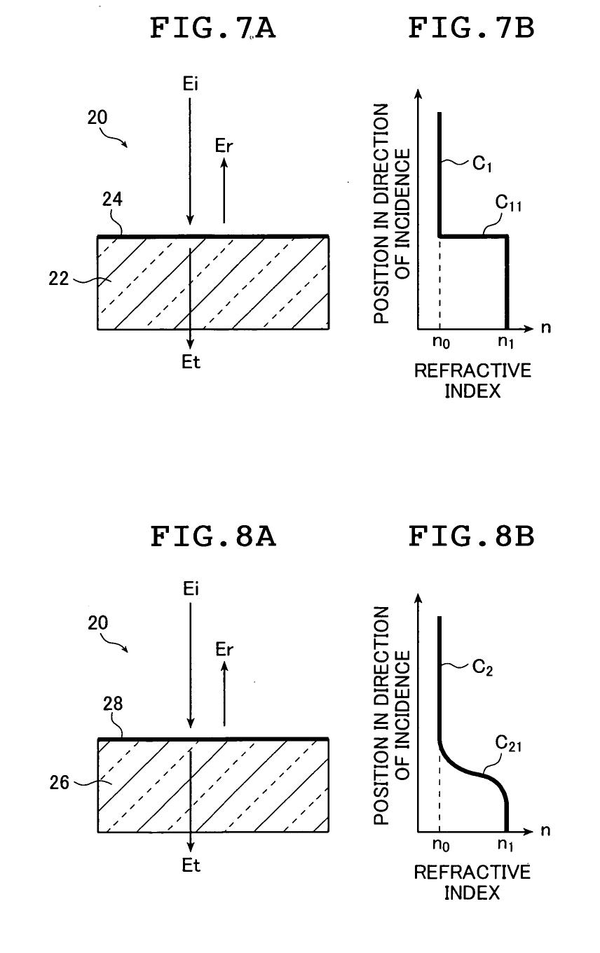

FIG. 7A is a view for illustrating reflection from a medium having a constant refractive index and FIG. 7B is a view showing the refractive index profile in FIG. 7A.

As shown in FIG. 7A, in the case where light Ei is incident at an incident angle of 0° from a medium 20 having a refractive index of n₀ on a medium 22 having a refractive index of n₁, part of the incident light Ei passes through the medium 22 as transmitted light Et and the remainder is reflected from a medium interface 24 as reflected light Er. In this case, the reflectance R at the medium interface 24 is represented by the expression 17.
R=(n₁−n₀)²/(n₁+n₀)² (17)

The relation of the reflectance R in the expression 17 is now applied to the protective film. In the protective film, the medium 20 is, for example, air. The air has a refractive index n₀ of 1. The medium 22 is, for example, glass. The glass has a refractive index n₁ of 1.5. From the expression 17, the reflectance R in the protective film is 4%.

In the refractive index profile C₁ in the direction of incidence, a stepped portion C₁₁ in which the refractive index greatly changes arises in the vicinity of the medium interface 24 as is seen from FIG. 7B. The reflected light Er is caused by discontinuity of the refractive index at the interface 24 between the two media (stepped portion C₁₁). Therefore, the reflectance can be reduced by eliminating the discontinuity of the refractive index, that is, the stepped portion C₁₁ where the refractive index greatly changes. In other words, use of a medium 26 (see FIG. 8A) having a continuous refractive index profile enables a change portion C₂₁ in which the refractive index profile C₂ in the direction of incidence continuously changes to be formed in the vicinity of a medium interface 28 whereby the light Er reflected from the medium interface 28 can be reduced. In other words, the reflectance can be reduced.

An exemplary method for reducing the quantity of the reflected light Er as described above is a method in which irregularities having a smaller size than the wavelength of the incident light Ei are formed on the incidence plane which the light strikes to allow the refractive index to change continuously to thereby reduce the quantity of the reflected light.

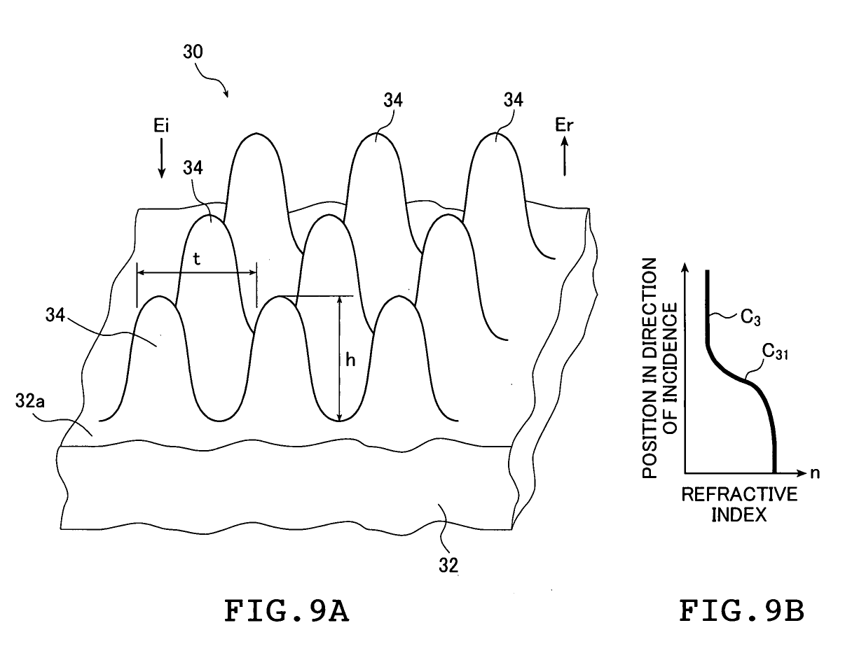

FIG. 9A is a view showing an uneven surface structure which reduces light reflection, and FIG. 9B is a view showing the refractive index profile in the uneven surface structure shown in FIG. 9A.

For example, an uneven surface structure 30 as shown in FIG. 9A is now described. In the uneven surface structure 30, projections 34 each having a height h are formed on a surface 32a of a substrate 32 at intervals t. The interval t between adjacent projections 34 is smaller than the wavelength of the incident light Ei. In this way, the uneven surface structure 30 acts on the incident light Ei as one having an averaged refractive index because the interval t is shorter than the wavelength of the light. The averaged refractive index is the one determined in the cross section cut at an arbitrary depth of the uneven surface structure 30. As a result, the refractive index of the uneven surface structure 30 continuously changes in the direction of incidence. As shown in FIG. 9B, in the refractive index profile C₃ of the uneven surface structure 30, no stepped portion arises but the profile continuously changes and a portion C₃₁ where the refractive index profile C₃ continuously changes arises in the vicinity of the surface of the uneven surface structure 30.

Assuming here that changes in refractive index are represented by a continuous function, n₀ represents a refractive index of a point z, and n₁ represents a refractive index of a point z+Δz, with the two points (z, z+Δz) being separated from each other by an infinitesimal distance Δz in the direction of light travel. In this case, if Δz approaches 0, n₁ approaches n₀. It turns out from the expression 17 that R approaches 0. More precisely, however, the reflectance R is optimized in relation to the height h.

The wavelength of light propagating through a medium is represented by λ/n (n is the refractive index of the medium) and is shorter than that in the air. It is desirable for the period t (nm) of the uneven surface microstructure to be smaller than the wavelength of light in the medium having the uneven surface microstructure (see the expression 18). Visible light has a wavelength range of 380 to 630 nm and light having the shortest wavelength (380 nm) need only satisfy the expression 11. When a fluoropolymer or Teflon® AF (fluororesin) is used for the material of the medium, its refractive index is 1.3. Therefore, the uneven surface microstructure need only have a period t of not more than 290 nm.
t≦λ/n₁ (18)

It is necessary for the uneven surface microstructure to have a sectional shape that enables the effective refractive index to change continuously. The effective refractive index is obtained by averaging the refractive index by the cross sectional ratio between air and the medium at an arbitrary depth, so it is also necessary for the cross sectional shape to change continuously. A dot pattern in which projections protrude individually or a hole pattern in which recesses are individually formed may be used for the pattern.

The depth h is calculated from the period t and the aspect ratio (h/t) (see Non-Patent Document 1), and when the relation represented by the expression 19 given below is satisfied, the reflectance R has a sufficiently low value.
h/t>0.4 (19)

When Teflon® AF (fluororesin) is used for the medium, the period t is equal to or smaller than 290 nm and the height h is equal to or larger than 120 nm. In this way, reflection can be prevented.

It turns out from the above that a protective film having excellent anti-smudging and antireflection properties can be obtained by satisfying both of the condition under which the contact angle is increased and the condition under which the light reflection can be reduced (the expressions 18 and 19).

Hereinafter, embodiments of the present invention will be described in detail.

[First embodiment]

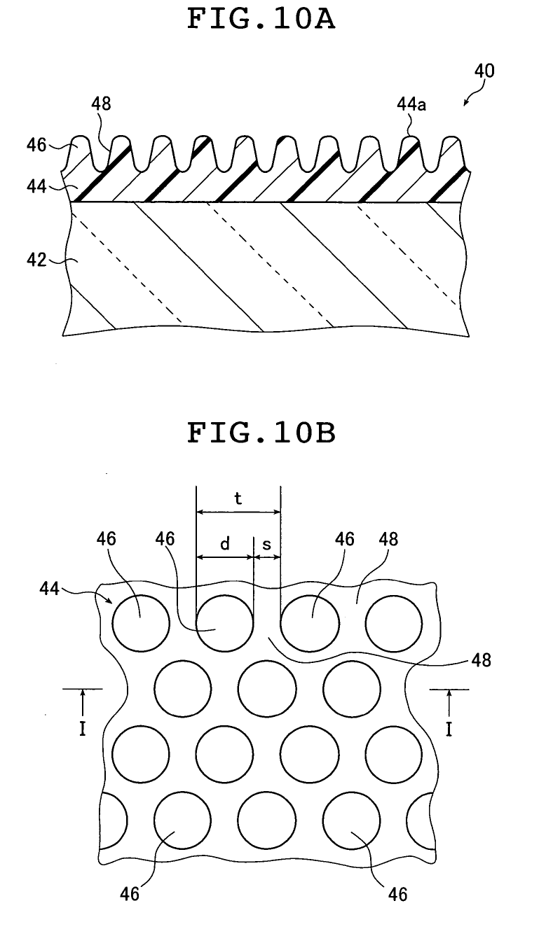

FIG. 10A is a schematic sectional view showing a protective film according to a first embodiment of the present invention, and Fig. 10B is a schematic plan view of the protective film shown in FIG. 10A.

As shown in FIG. 10A, a protective film 40 in this embodiment includes a supporting substrate 42 and a protective layer 44 formed on a surface of the supporting substrate 42.

The supporting substrate 42 supports the protective layer 44 and its surface is flat. The supporting substrate 42 is formed from, for example, a plastic film that is transparent in a visible light wavelength range of 380 nm to 630 nm.

The plastic film that may be used for the supporting substrate 42 is preferably formed of, for example, cellulose ethers such as triacetyl cellulose, diacetyl cellulose and propionyl cellulose or polyolefins such as polypropylene, polyethylene and polymethylpentene.

The protective layer 44 is a nonreflective, anti-smudging layer having excellent anti-smudging performance and antireflection performance. As shown in FIGS. 10A and 10B, projections 46 and recesses 48 are periodically and continuously formed on a surface 44a of the protective layer 44 side by side. The protective layer 44 has the uneven surface structure obtained by periodically and continuously forming projections 46 and the recesses 48.

It is necessary for the material of the protective layer 44 to have high transparency in the visible light wavelength range of 380 nm to 630 nm and to be low in surface tension. Examples of the material that satisfies these conditions include fluoropolymers, ethylene tetrafluoroethylene (ETFE), CYTOP® and Teflon® AF. These materials are low in surface tension and refractive index and are transparent in the visible light region. The protective layer 44 in this embodiment is thus made of a fluorine-containing material.

FIG. 11 is a sectional view taken along the line I-I in FIG. 10B.

As described above, the uneven surface structure obtained by forming the projections 46 and the recesses 48 on the surface of the protective layer 44 have a periodic structure having continuous and regular periodicity as in a sinusoidal function. The uneven surface structure has regular periodicity, so the tip of each projection 46 has a continuously changing shape. Therefore, the tip of each projection 46 (including a curved portion 46c) preferably has a predetermined curvature.

As shown in FIG. 11, in the uneven surface structure of the protective layer 44, the projections 46 and the recesses 48 are formed at intervals t. The projections 46 each have a height h and a width d.

The height h of each projection 46 refers to the distance between the top 46a of the projection 46 and the bottom of the recess 48.

The width d of each projection 46 will be described below.

A vertical line V is drawn at a height h/2 of the projection 46 to obtain first tangents Tb formed at points Q at which the vertical line V intersects a lateral wall 46b of the projection 46. A second tangent Ta is formed at the top 46a of the projection 46. The first tangents Tb and the second tangent Ta in one projection 46 intersect each other at points w. The distance between the two points w in one projection 46 is the width d of the projection 46.

The period t at which the projections 46 and the recesses 48 constituting the uneven surface structure are formed refers to the cycle length of repeatedly formed projections 46 and recesses 48 and more specifically the distance between the two points w on the same side of adjacent two projections 46. The width s of the recess 48 is obtained by subtracting the width d of the projection from the period t.

Next, conditions necessary for preventing reflection in the protective film 40 of this embodiment will be described. The protective layer 44 in the protective film 40 of this embodiment satisfies the expressions 18 and 19.

The shortest wavelength of visible light is set at, for example, 380 nm and the protective layer 44 is made of, for example, Teflon® AF (refractive index: 1.3). In this case, the protective layer 44 has a refractive index nb of 1.3.

As for the conditions necessary for preventing reflection, a period t of not more than 290 nm is obtained from the expression 18 and a height h of the projection 46 of at least 120 nm is obtained from the expression 19.

Next, conditions necessary for achieving antireflection and anti-smudging properties in the protective film 40 of this embodiment will be described below.

In order to achieve the antireflection and anti-smudging properties in the protective film 40 of this embodiment, the area ratio of the projections in the uneven surface structure that is determined by the expression 16 is not more than 60% and preferably not more than 40%.

In the case where the period t is 290 nm and the area ratio is 60%, the width d of the projection 46 determined by the expression 16 is 167 nm. As is seen from FIG. 11, the recess 48 has a width s of 123 nm (=290 nm−167 nm).

In addition, the projection 46 has preferably a smaller radius of curvature ρ than the width s of the recess 48 and the height h of the projection 46 (depth h of the recess 48). Assuming here that the projection 46 has a width d of 167 nm and a radius of curvature ρ of d/2, the radius of curvature ρ is 83.5 nm. This radius of curvature ρ is smaller than the width s (=123 nm) of the recess 48 and the height h (=120 nm) of the projection 46. In this way, the uneven surface structure that satisfies both of the condition under which the antireflection properties are exhibited and the condition under which the anti-smudging properties are exhibited is obtained.

The curved portion 46c of the projection 46 has an angle β of not more than 126° and desirably not more than 115°.

The method of producing the protective film 40 of this embodiment will be described below.

A supporting substrate 42 that is transparent in the visible light region is first prepared. The supporting substrate 42 is made of, for example, cellulose ether or polyolefin.

Then, the surface of the supporting substrate 42 is coated with a material constituting the protective layer 44 which is selected from among fluoropolymers, ethylene tetrafluoroethylene (ETFE), CYTOP® and Teflon® AF, whereby a coating layer is formed thereon.

A die in which a bumpy pattern for the uneven surface structure is formed is pressed against the coating layer surface before the temperature of the coating is increased or is pressed against the coating surface whose temperature has been increased. The coating surface is then solidified to transfer the pattern of the die to the coating layer surface.

Then, the die is separated from the coating layer. In this way, the protective film 40 in this embodiment can be produced.

In this embodiment, the die used for the projections 46 and the recesses 48 has irregularities (not shown) formed on a base (not shown). The irregularities are used to form the projections 46 and the recesses 48 of the protective layer 44. The irregularities of the base are formed to have a bumpy pattern satisfying the shape, size and the area ratio that allow the anti-reflection function and anti-smudging function described above to be exhibited. The die has the irregularities that were formed by lithography, dry etching or plating so as to have the bumpy pattern.

In the protective film 40 of this embodiment, the protective layer 44 has the projections 46 and the recesses 48 formed so as to have the shape, size and area ratio that allow the antireflection and anti-smudging properties to be exhibited, whereby the light reflection can be reduced while the contact angle of oil as the principle component of smudges can be increased. The protective film 40 of this embodiment thus reduces reflection of outside light or fluorescent light of the fluorescent lamp on its surface, whereby the visibility of displayed images is enhanced while the burden on the eyes of an operator can be reduced. In addition, fingerprints, sebum, sweat, cosmetics and the like are not readily adhered to the protective film and even if fingerprints, sebum, sweat, cosmetics and the like are adhered, they are readily removed.

Accordingly, in the case where a display screen of any of various monitors or a touch panel display screen is provided with the protective film 40 of this embodiment, excellent visibility, high resistance to smudging and easy removal of smudges are achieved to prevent the visibility from being reduced by smudges while the operation for smudge removal can be simplified owing to the high resistance to smudging. The protective film 40 of this embodiment can be thus appropriately attached to the display screen of any of various unmanned monitors or the touch panel display screen.

[Second embodiment]

Next, a protective film according to a second embodiment of the present invention will be described. In this embodiment, the same components as those in the first embodiment shown in FIGS. 10A, 10B and 11 are denoted by the same reference numerals and their detailed description will be omitted.

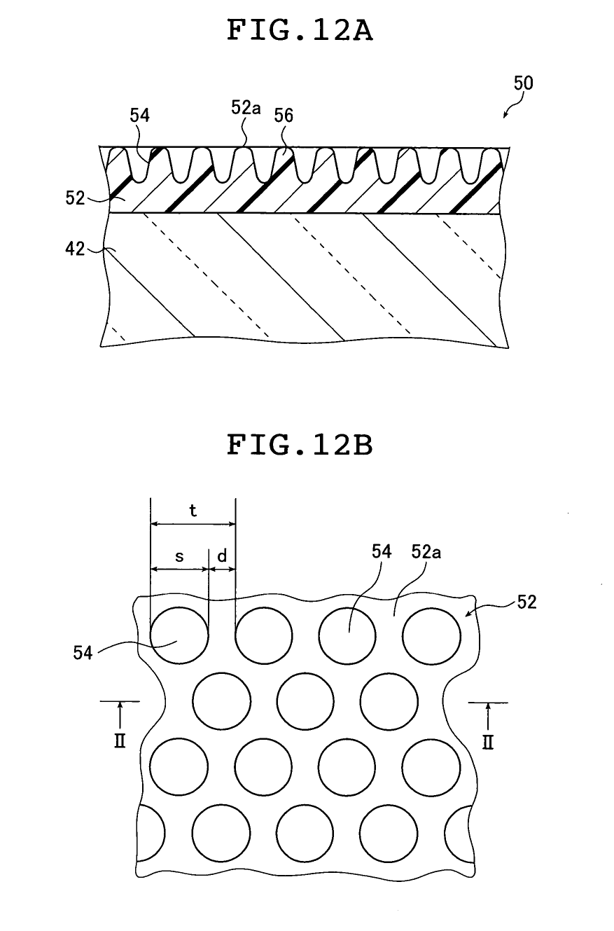

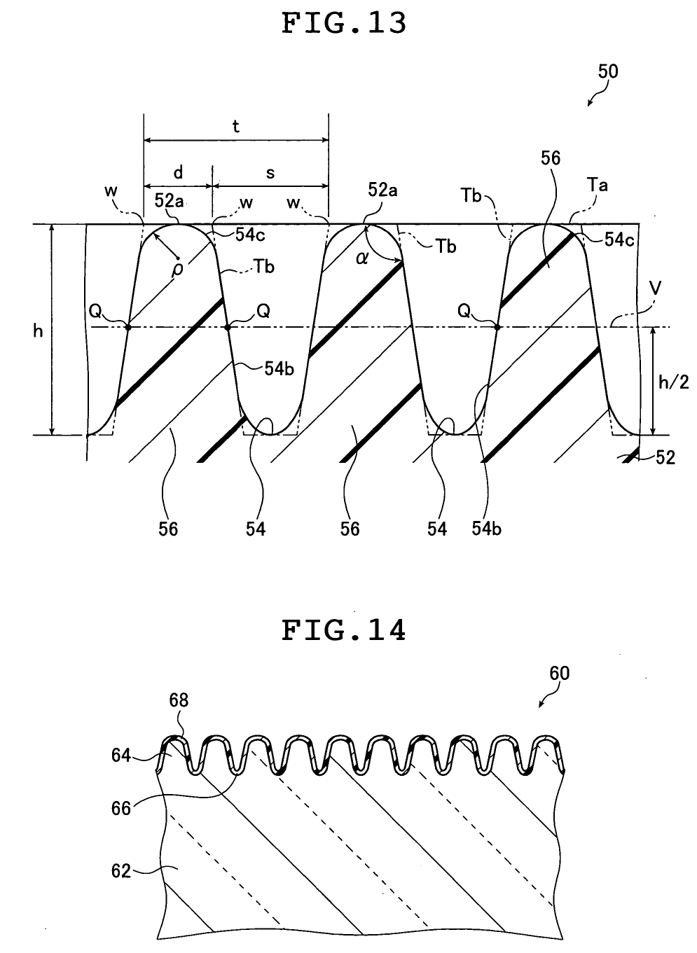

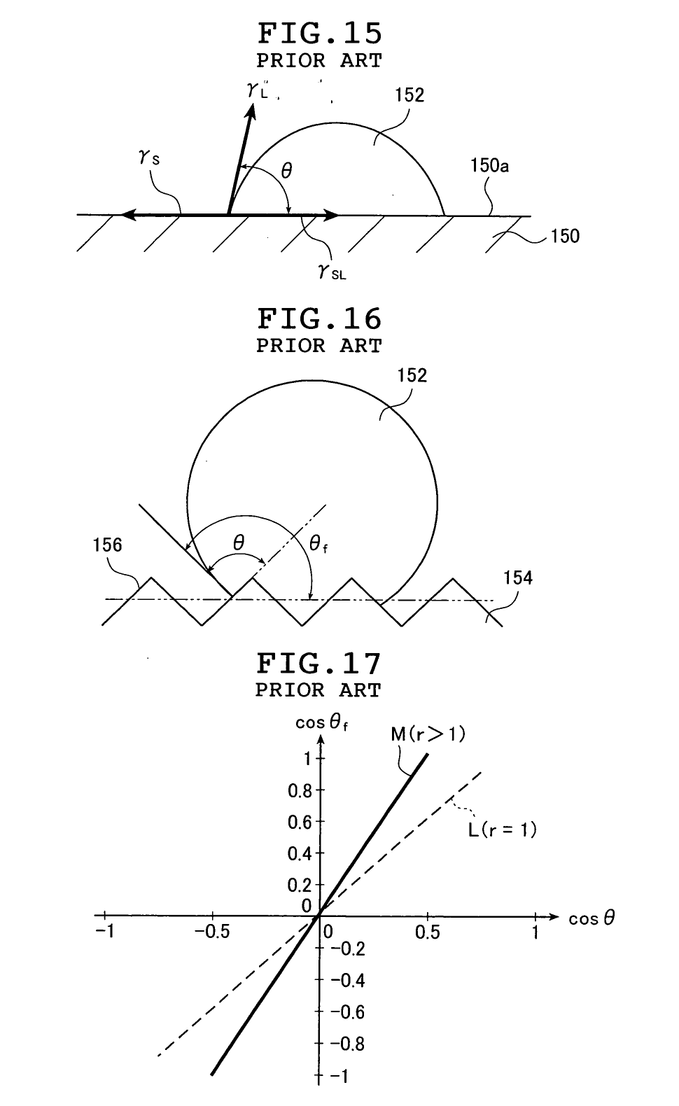

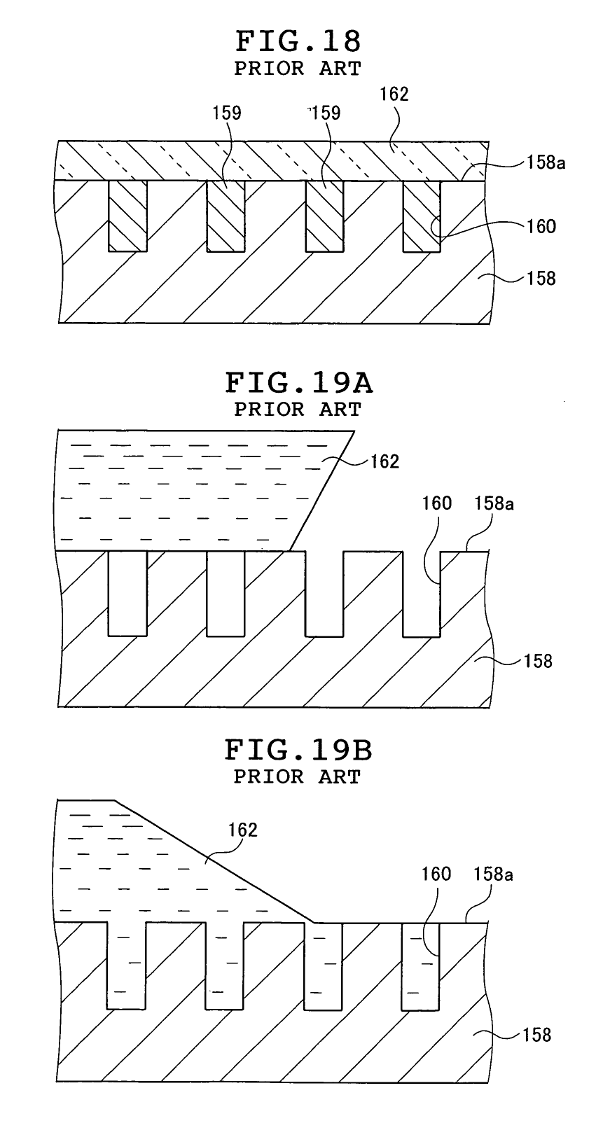

FIG. 12A is a schematic sectional view showing the protective film according to the second embodiment of the present invention, and FIG. 12B is a schematic plan view of the protective film shown in FIG. 12A. FIG. 13 is a sectional view taken along the line II-II in FIG. 12B.

As shown in FIG. 12A, the protective film 50 in this embodiment is different from the protective film 40 in the first embodiment (see FIG. 10A) in the structure of the protective layer 52 but the former is the same as the latter in the structures of the other portions, so their detailed description will be omitted.

As shown in FIGS. 12A and 12B, the protective layer 52 of this embodiment has recesses 54 formed on its surface 52a at predetermined intervals. As shown in FIG. 12A, the space between adjacent two recesses 54 in the protective layer 52 is regarded as a projection 56.

As shown in FIG. 13, the protective layer 52 has an uneven surface structure (periodic structure) in which the recesses 54 and the projections 56 are continuously and periodically formed. The uneven surface structure of the protective layer 52 has continuous and regular periodicity as in a sinusoidal function. The uneven surface structure has regular periodicity and the recess 54 has a curved portion 54c of continuously changing shape. Therefore, the curved portion 54c has preferably a predetermined curvature.

As in the protective layer 44 of the first embodiment, the protective layer 52 need only be made of a fluorine-containing material. Examples of the material constituting the protective layer 52 include fluoropolymers, ethylene tetrafluoroethylene (ETFE), CYTOP® and Teflon® AF.

As shown in FIG. 13, in the protective layer 2 having the uneven surface structure, the recesses 54 and the projections 56 are formed at intervals t. The recesses 54 each have a depth h.

The depth h of the recess 54 refers to the distance between the surface of the protective layer 52 and the bottom of the recess 54.

The projection 56 of this embodiment has a width d defined in the same manner as the projection 46 of the first embodiment (see FIG. 11). The width d of the projection 56 is obtained as follows: A vertical line V is drawn at a height h/2 of the projection 56 to obtain first tangents Tb formed at points Q at which the vertical line V intersects an inner wall 54b of the recess 54; a second tangent Ta is formed at the surface 52a of the protective layer 52; that is, at the top of the projection 56; the first tangents Tb and the second tangent Ta in one projection 56 intersect each other at points w; and the distance between the two points w in one projection 56 is regarded as the width d of the projection 56. The recess 54 has a width s obtained by subtracting the width d of the projection 56 from the period t.

The protective film 50 of this embodiment should have the same conditions necessary for preventing reflection as the protective film 40 of the first embodiment. In the case where Teflon® AF (refractive index: 1.3) is used for the protective layer 52, the period t is not more than 290 nm and the depth h of each recess 54 is at least 120 nm.

In the protective film 50 of this embodiment, the area ratio of the recesses 54 in the uneven surface structure which is necessary to achieve the antireflection and anti-smudging properties and which is obtained by the expression 15 is preferably at least 20% and more preferably at least 40%.

In the case where a period t of 290 nm and an area ratio of the recesses 54 of 20% are obtained from the expression 15, the projection 56 has a width d of 118 nm. In addition, as is seen from FIG. 13, the recess 54 has a width s of 172 nm (=290 nm−118 nm).

It is preferable for the boundary between the inner wall 54b of the recess 54 and the surface 52a of the protective layer 52 to have a smaller radius of curvature ρ than the width s of the recess 54 and the height h of the projection 56 (depth h of the recess 54). Assuming here that the radius of curvature ρ is d/2, the radius of curvature ρ is 59 nm. The radius of curvature ρ is smaller than the width s (=172 nm) of the recess 54 and the depth h (=170 nm) of the recess 54. In this way, the uneven surface structure that satisfies both of the condition under which the antireflection properties are exhibited and the condition under which the anti-smudging properties are exhibited is obtained in this embodiment.

The inner wall 54b of the recess 54 and the surface 52a of the protective layer 52 form an angle a (angle α in the curved portion 54c of the recess 54) of not more than 126° and desirably not more than 115°.

The method of producing the protective film 50 of this embodiment is also the same as that for the protective film 40 of the first embodiment, so its detailed description will be omitted.

A supporting substrate 42 that is transparent in the visible light region is first prepared. The supporting substrate 42 is made of, for example, cellulose ether or polyolefin.

Then, the surface of the supporting substrate 42 is coated with a material constituting the protective layer 52 which is selected from among fluoropolymers, ethylene tetrafluoroethylene (ETFE), CYTOP® and Teflon® AF, whereby a coating layer is formed thereon.

A die in which a pattern for the uneven surface structure is formed is pressed against the coating layer surface before the temperature of the coating layer is increased or is pressed against the coating layer surface whose temperature has been increased. The coating layer surface is then solidified to transfer the pattern of the die to the coating layer surface. Then, the die is separated from the coating layer. In this way, the protective film 50 in this embodiment can be produced.

It is needless to say that the protective film 50 of this embodiment can achieve the same effects as those in the protective film 40 of the first embodiment.

[Third embodiment]

Next, a protective film 60 according to a third embodiment of the present invention will be described. In this embodiment, the same components as those in the first embodiment shown in FIGS. 10A, 10B and 11 are denoted by the same reference numerals and their detailed description will be omitted.

FIG. 14 is a schematic sectional view showing the protective film according to the third embodiment of the present invention.

As shown in FIG. 14, the protective film 60 of this embodiment is the same as the protective film 40 of the first embodiment (see FIG. 10A) except that the protective layer 44 is not formed but projections 64 and recesses 66 are formed on a supporting substrate 62 that is transparent in the visible light region, and that an anti-smudging layer 68 is formed on the projections 64 and the recesses 66 of the supporting substrate 62, so its detailed description will be omitted.

For example, cellulose ethers such as triacetyl cellulose, diacetyl cellulose and propionyl cellulose or polyolefins such as polypropylene, polyethylene and polymethylpentene can be used for the supporting substrate 62. The supporting substrate 62 of this embodiment satisfies the expressions 18 and 19.

The anti-smudging layer 68 itself is liquid repellent and is made of, for example, a fluorine-based, low-molecular weight material such as a perfluoro group-containing fluoroalkylsilane.

The anti-smudging layer 68 is sufficiently thin to enable the uneven surface structure formed by the projections 64 and the recesses 66 on the supporting substrate 62 to be maintained. The anti-smudging layer 68 has a thickness of, for example, not more than 10 nm.

The thickness of the anti-smudging layer 68 of not more than 10 nm is sufficiently thin compared with the condition under which the antireflection properties are exhibited and the condition under which the anti smudging properties are exhibited, and the localized uneven surface structure of the supporting substrate 62 is maintained without adversely affecting the uneven surface structure satisfying the condition under which the antireflection properties are exhibited and the condition under which the anti-smudging properties are exhibited.

The condition under which the antireflection properties are exhibited on the protective film 60 of this embodiment having the uneven surface structure is that the supporting substrate 62 has a refractive index of about 1.4. Although more or less larger than in the first and second embodiments, this value enables both of the antireflection properties and the anti-smudging properties to be exhibited.

By providing the protective film 60 of this embodiment including the anti-smudging layer 68, two effects can be achieved, in other words, liquid repellency can be exhibited owing to the surface structure having irregularities locally formed based on the projections and recesses on the supporting substrate 62 while at the same time, liquid repellency owing to the anti-smudging layer 68 can be exhibited.

The method of producing the protective film 60 of this embodiment is also the same as that for the protective film 40 of the first embodiment, so its detailed description will be omitted.

A supporting substrate 62 that is transparent in the visible light region is first prepared. The supporting substrate 62 is made of, for example, cellulose ether or polyolefin.

A die in which a pattern for the uneven surface structure is formed is pressed against the surface of the supporting substrate 62 before its temperature is increased or is pressed against the surface of the supporting substrate 62 whose temperature has been increased. The surface of the supporting substrate 62 is then solidified to transfer the pattern of the die to the surface of the supporting substrate 62. Then, the die is separated from the surface of the supporting substrate 62.

Then, for example, oxygen plasma is used to clean the projections 64 and the recesses 66.

Then, the anti-smudging layer 68 that is sufficiently thin to enable the uneven surface structure obtained by forming the projections 64 and the recesses 66 on the supporting substrate 62 to be maintained, for example the anti-smudging layer 68 that has a thickness of not more than 10 nm is formed on the projections 64 and the recesses 66, for example, by spin coating, vacuum deposition, vapor adsorption or a method involving immersion in liquid. In this way, the protective film 60 shown in FIG. 14 can be produced.

It is needless to say that the protective film 60 of this embodiment can achieve the same effects as those in the protective film 40 of the first embodiment.

A bottom substrate that is transparent in the visible light region may be formed on the back side of the supporting substrate 62 in the protective film 60 of this embodiment.

In addition, the uneven surface structure formed on the supporting substrate 62 in this embodiment is not limited to the one obtained by forming the projections 64 on the surface of the supporting substrate 62, but the one obtained by forming recesses on the surface of the supporting substrate 62 as in the second embodiment may be applied.

As mentioned above, the protective film of the present invention can prevent smudges due to, for example, fingerprints, sebum, sweat and cosmetics and hence be advantageously used for a filter to be attached to the surface of a touch panel or any of various monitors.

While the protective film of the present invention has been described above in detail with reference to various embodiments, it should be noted that the invention is by no means limited to such embodiments but various improvements and modifications may of course be made without departing from the scope and spirit of the invention.

What is claimed is:

1. A protective film comprising:
a transparent supporting substrate; and
a protective layer which is formed on a surface of the supporting substrate and contains fluorine,
wherein the protective layer has an uneven surface structure obtained by periodically and continuously forming recesses and projections and the uneven surface structure satisfies relations of t≦390/nb (nm) and h/t≧0.4 where t represents a period (nm) of the uneven surface structure, h represents a height (nm) which is a distance between a top of each of the projections and a bottom of each of the recesses, and nb represents a refractive index of the protective layer.

2. The protective film according to claim 1, wherein each of the projections has a tip whose radius of curvature is less than smaller one of a width and a depth of each of the recesses.

3. The protective film according to claim 1, wherein each of the projections has a tip whose radius of curvature is equal to or less than half of smaller one of a width and a depth of each of the recesses.

4. The protective film according to claim 1, wherein an area ratio of the projections to the protective layer is not more than 60%.

5. The protective film according to claim 1, wherein an area ratio of the projections to the protective layer is not more than 40%.

6. The protective film according to claim 1, wherein an area ratio of the recesses to the protective layer is at least 20%.

7. The protective film according to claim 1, wherein an area ratio of the recesses to the protective layer is at least 40%.

8. A protective film comprising:
a transparent supporting substrate which has an uneven surface structure obtained by periodically and continuously forming recesses and projections on its surface, the uneven surface structure satisfying relations of t≦390/nb (nm) and h/t≧0.4 where t represents a period (nm) of the uneven surface structure, h represents a height (nm) which is a distance between a top of each of the projections and a bottom of each of the recesses, and nb represents a refractive index; and
an anti-smudging layer which is formed on the surface of the supporting substrate while the uneven surface structure is maintained and which is made of a fluorine-containing material.

9. The protective film according to claim 8, wherein each of the projections has a tip whose radius of curvature is less than smaller one of a width and a depth of each of the recesses.

10. The protective film according to claim 8, wherein each of the projections has a tip whose radius of curvature is equal to or less than half of smaller one of a width and a depth of each of the recesses.

11. The protective film according to claim 8, wherein an area ratio of the projections to the supporting substrate is not more than 60%.

12. The protective film according to claim 8, wherein an area ratio of the projections to the supporting substrate is not more than 40%.

13. The protective film according to claim 8, wherein an area ratio of the recesses to the supporting substrate is at least 20%.

14. The protective film according to claim 8, wherein an area ratio of the recesses to the supporting substrate is at least 40%.

15. The protective film according to claim 8, wherein a bottom substrate is provided on a back side of the supporting substrate.
